(19) United States
(12) Patent Application Publication
(10) Pub. No.: US 2026/0242273 A1
(43) Pub. Date: Aug. 20, 2026

(54) GLASS BASE MATERIAL MANUFACTURING DEVICE AND METHOD OF MANUFACTURING GLASS BASE MATERIAL

(71) Applicant: SUMITOMO ELECTRIC INDUSTRIES, LTD., Osaka (JP)

(72) Inventors: Wataru Kikuchi, Osaka (JP); Shinji Ishikawa, Osaka (JP); Tatsuro Hasegawa, Osaka (JP)

(21) Appl. No.: 19/536,521

(22) Filed: Feb. 11, 2026

(30) Foreign Application Priority Data
Feb. 14, 2025 (JP) 2025-022654

(51) Int. Cl. C03B 37/014; C03B 5/237; C03B 5/43

(52) U.S. Cl. CPC C03B 37/0146; C03B 5/2375; C03B 5/43

(57) ABSTRACT

A glass base material manufacturing device includes: a heating furnace; a heater disposed inside the heating furnace; a furnace core tube disposed inside the heater and configured to accommodate a porous glass base material inside thereof; a top lid configured to close an upper opening of the furnace core tube; a vacuum pump configured to evacuate the inside of the furnace core tube and the heating furnace; a first pressure gauge configured to measure pressure inside the furnace core tube; a second pressure gauge configured to measure pressure inside the heating furnace but outside the furnace core tube; and a gas supply device configured to supply fluorine-compound-containing gas to the inside of the furnace core tube.

### TECHNICAL FIELD

The present disclosure relates to a glass base material manufacturing device and a method of manufacturing a glass base material. This application claims priority based on Japanese Patent Application No. 2025-022654 filed on Feb. 14, 2025, and the entire contents of which are incorporated herein by reference.

### BACKGROUND

JPH09-100129A discloses a device that includes a furnace core tube in a heating furnace, arranges a porous glass base material inside the furnace core tube, and consolidates the porous glass base material under vacuum in the heating furnace. JPH07-291635A discloses a method of manufacturing synthetic quartz glass by adding fluorine at the time of manufacturing porous glass and performing vacuum consolidation in a consolidation process.

### SUMMARY

An object of the present disclosure is to provide a glass base material manufacturing device capable of adding fluorine at a high concentration to the glass during a vacuum consolidation process.

A glass base material manufacturing device according to an embodiment of the present disclosure includes a heating furnace, a heater disposed inside the heating furnace; a furnace core tube disposed inside the heater and configured to accommodate a porous glass base material inside thereof; a top lid configured to close an upper opening of the furnace core tube; a vacuum pump configured to evacuate the inside of the furnace core tube and the heating furnace; a first pressure gauge configured to measure pressure inside the furnace core tube; a second pressure gauge configured to measure pressure inside the heating furnace but outside the furnace core tube; and a gas supply device configured to supply fluorine-compound-containing gas to the inside of the furnace core tube.

### BRIEF DESCRIPTION OF THE DRAWINGS

FIG. 1 is a schematic diagram of a glass base material manufacturing device according to an embodiment of the present disclosure.

FIG. 2 is a cross-sectional view illustrating an example of a configuration of a furnace core tube and a top lid.

FIG. 3 is a cross-sectional view illustrating another example of the configuration of the furnace core tube and the top lid.

FIG. 4 is a cross-sectional view illustrating still another example of the configuration of the furnace core tube and the top lid.

### DETAILED DESCRIPTION

When performing vacuum consolidation, fluorine tends to escape from the glass and is difficult to retain, and thus it is difficult to obtain glass with fluorine at a high concentration.

According to the present disclosure, fluorine can be added at a high concentration to the glass base material in the vacuum consolidation process.

### Description of Embodiment of Present Disclosure

First, embodiments of the present disclosure are listed and described. (1) A glass base material manufacturing device according to an embodiment of the present disclosure includes a heating furnace, a heater disposed inside the heating furnace; a furnace core tube disposed inside the heater and configured to accommodate a porous glass base material inside thereof; a top lid configured to close an upper opening of the furnace core tube; a vacuum pump configured to evacuate the inside of the furnace core tube and the heating furnace; a first pressure gauge configured to measure pressure inside the furnace core tube; a second pressure gauge configured to measure pressure inside the heating furnace but outside the furnace core tube; and a gas supply device configured to supply fluorine-compound-containing gas to the inside of the furnace core tube.

With this configuration, it is possible to confirm whether fluorine-compound-containing gas can be sufficiently supplied to the inside of the furnace core tube by maintaining the pressure inside the furnace core tube higher than the pressure outside the furnace core tube but in the heating furnace. Accordingly, a high concentration of fluorine can be added to the glass base material in the vacuum consolidation process. Furthermore, by adding fluorine in a state in which the pressure inside the furnace core tube is higher than the pressure outside the furnace core tube, there is no need to supply an excessive amount of fluorine-compound-containing gas, thereby reducing the usage amount of gas.

(2) The manufacturing device of (1) may further include a differential pressure gauge configured to display a differential pressure between the pressure inside the furnace core tube and the pressure inside the heating furnace but outside the furnace core tube. By providing the differential pressure gauge, the airtight state of the furnace core tube can be easily determined, and a high concentration of fluorine can be more reliably added to the porous glass base material.

(3) The manufacturing device according to (1) or (2) may further include a control device configured to control a flow rate of gas supplied to the inside of the furnace core tube so that a measurement value of the first pressure gauge is predetermined set pressure. By adjusting the pressure inside the furnace core tube to a predetermined set pressure, it is possible to more reliably add fluorine at a high concentration to the porous glass base material.

(4) The manufacturing device according to (1) or (3) may further include a control device configured to control a flow rate of gas exhausted from the inside of the furnace core tube so that a measurement value of the first pressure gauge is predetermined set pressure. By adjusting the pressure inside the furnace core tube to a predetermined set pressure, it is possible to more reliably add fluorine at a high concentration to the porous glass base material.

(5) In any one of (1) to (4), the top lid may include a cap lid structure that covers an upper side surface of the furnace core tube. If the top lid has a cap lid structure, the top lid fits more closely to the furnace core tube, and airtightness is improved. Therefore, it is easier to increase the pressure inside the furnace core tube.

(6) In any one of (1) to (5), a protrusion that protrudes toward the top lid may be provided at an upper end of the furnace core tube, and the protrusion may come into contact with the top lid, thereby sealing an upper opening of the furnace core tube. By providing the protrusion, the surface pressure increases at a contact point between the furnace core tube and the protrusion. Therefore, the protrusion is bitten into the top lid, and the furnace core tube is sealed, thereby improving the airtightness of the furnace core tube.

(7) In any one of (1) to (6), a tapered portion of an upper end of the furnace core tube and a tapered portion of the top lid may be fitted to seal the upper opening of the furnace core tube. The fitting of the tapered portions improves the airtightness of the furnace core tube.

(8) In (7), an angle formed by a fitting portion between the tapered portion of the upper end of the furnace core tube and the tapered portion of the top lid may be 5 degrees to 45 degrees. By setting the angle of the fitting portions to 5 to 45 degrees, the top lid is aligned when the tapered portions are fitted, and the center of the top lid is positioned on the central axis of the furnace core tube.

(9) In any one of (1) to (8), the top lid may include a sealing chamber, and a rod configured to support the porous glass base material may be configured to pass through the sealing chamber. By providing a sealing chamber, it is possible to reduce leakage of gas from the inside of the furnace core tube and improve airtightness.

(10) A method of manufacturing a glass base material according to an embodiment of the present disclosure is a method of manufacturing a glass base material using the glass base material manufacturing device according to any one of claims (1) or (9) and includes heating a porous glass base material accommodated in the furnace core tube to 1,000° C to 1,400° C by the heater and supplying fluorine-compound-containing gas to the furnace core tube in a state in which pressure measured by the first pressure gauge is greater than pressure measured by the second pressure gauge, and a pressure difference between the first pressure gauge and the second pressure gauge is maintained at 5 Pa to 10,000 Pa. According to this configuration, it is possible to add fluorine to the glass base material at a high concentration in the vacuum consolidation process while reducing the usage amount of fluorine-compound-containing gas.

(11) In (10), the fluorine-compound-containing gas is CF₄. By using gas including CF₄, it is possible to appropriately add fluorine to the glass base material.

### Details of Embodiment of Present Disclosure

Specific examples of the glass base material manufacturing device and the method of manufacturing of a glass base material according to the present disclosure are described below with reference to the drawings. Note that the present invention is not limited to these examples and is defined by the claims, and all modifications within the meaning and scope of the claims are intended to be included.

### Glass Base Material Manufacturing Device

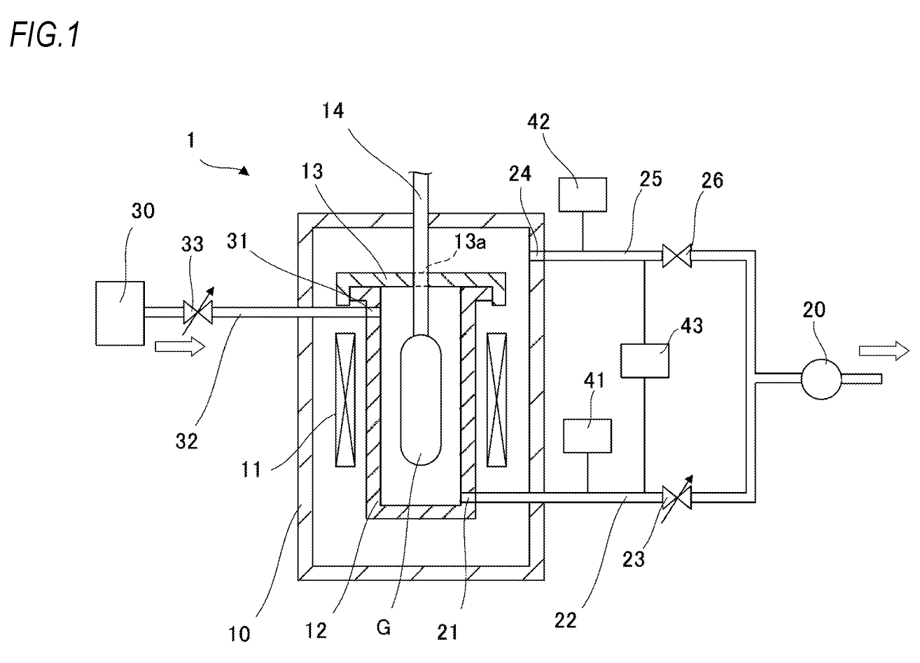

First, the glass base material manufacturing device of the present disclosure is described. FIG. 1 is a schematic diagram illustrating a glass base material manufacturing device 1 according to an embodiment of the present disclosure. As illustrated in FIG. 1, the glass base material manufacturing device 1 includes a heating furnace 10, a heater 11, a furnace core tube 12, and a top lid 13. FIG. 1 illustrates a state in which a porous glass base material G formed by depositing glass fine particles on a rod 14 is inserted into the furnace core tube 12.

The heating furnace 10 is a furnace for consolidating the porous glass base material G to obtain a glass base material. The heater 11 is disposed inside the heating furnace 10, and the furnace core tube 12 is disposed inside the heater 11. The upper portion of the furnace core tube 12 is open, and thus the porous glass base material G formed on the rod 14 is inserted into the furnace core tube 12 from above. By heating the porous glass base material G with the heater 11 in a state in which the porous glass base material G is inserted into the furnace core tube 12, it is possible to heat and consolidate the porous glass base material G. The top lid 13 is a member that closes the upper opening of the furnace core tube 12. The rod 14 passes through the top lid 13 through a hole 13a provided in the top lid 13, and the position of the porous glass base material G can be adjusted by moving the rod 14 upward or downward.

The upper opening of the furnace core tube 12 is closed by the top lid 13, thereby sealing the furnace core tube 12. That is, the top lid 13 and the furnace core tube 12 are configured to be in contact with each other without any gaps. Furthermore, in order to seal the furnace core tube 12, a gap between the top lid 13 and the rod 14 is designed to be sufficiently small. Specific examples of the configuration of each member for improving the airtightness of the furnace core tube 12 are described below.

As illustrated in FIG. 1, the manufacturing device 1 includes a vacuum pump 20. The inside of the furnace core tube 12 is evacuated with the vacuum pump 20, thereby consolidating the porous glass base material G in a vacuum state. More specifically, the furnace core tube 12 is provided with a gas exhaust port 21, and the gas exhaust port 21 is connected to the vacuum pump 20 via a gas exhaust pipe 22. The gas exhaust pipe 22 is provided with a flow control valve 23, and the flow rate of the gas exhausted through the gas exhaust pipe 22 can be controlled by adjusting the aperture of the flow control valve 23 using a control unit (not illustrated). As described below, the flow control valve 23 is an example of a control device that controls the flow rate of the gas exhausted from the furnace core tube 12. Also, the heating furnace 10 is also provided with a gas exhaust port 24, and the gas exhaust port 24 is connected to the vacuum pump 20 via a gas exhaust pipe 25. The gas exhaust pipe 25 is provided with a gate valve 26, and gas exhausted from the heating furnace 10 can be controlled by the control unit (not illustrated) controlling the gate valve 26.

As illustrated in FIG. 1, the manufacturing device 1 includes a gas supply device 30, and gas can be supplied from the gas supply device 30 to the inside of the furnace core tube 12. More specifically, the furnace core tube 12 is provided with a gas supply port 31, and the gas supply port 31 is connected to the gas supply device 30 via a gas supply pipe 32. The gas supply pipe 32 is provided with a flow control valve 33, and the flow rate of the gas supplied to the furnace core tube 12 can be controlled by adjusting the aperture of the flow control valve 33 with the control unit (not illustrated).

The gas supply device 30 supplies fluorine-compound-containing gas to the furnace core tube 12. By introducing the fluorine-compound-containing gas and performing heating during the heating process of the porous glass base material, fluorine can be added to a portion of the glass base material corresponding to the cladding. By adding fluorine, a refractive index of the cladding can be lowered.

As illustrated in FIG. 1, each of the gas exhaust pipe 22 connected to the gas exhaust port 21 of the furnace core tube 12, and the gas exhaust pipe 25 connected to the gas exhaust port 24 of the heating furnace 10 is provided with a pressure gauge. In the following description, a pressure gauge provided in the gas exhaust pipe 22 is referred to as a first pressure gauge 41, and a pressure gauge provided in the gas exhaust pipe 25 is referred to as a second pressure gauge 42. Because the first pressure gauge 41 is connected to the gas exhaust port 21, the first pressure gauge can measure the pressure inside the furnace core tube 12. Because the second pressure gauge 42 is connected to the gas exhaust port 24, the second pressure gauge can measure the pressure inside the heating furnace 10 but outside the furnace core tube 12. For convenience, in the following description, the space "inside the heating furnace 10 but outside the furnace core tube 12" where the pressure is measured by the second pressure gauge 42 may be simply referred to as "inside the heating furnace 10".

Next, a process of manufacturing a glass base material using the glass base material manufacturing device 1 is described. The process of manufacturing a glass base material described below is a process of obtaining a glass base material by dehydrating, consolidating, and clarifying the porous glass base material G supported by the rod 14 in a vacuum.

First, the rod 14 supporting the porous glass base material G is inserted into the furnace core tube 12 from above. With the rod 14 inserted, the upper opening of the furnace core tube 12 is closed with the top lid 13, and the furnace core tube 12 is sealed. As illustrated in FIG. 1, the porous glass base material G is disposed in a position heated by the heater 11, that is, in a heat zone that is the height range from the upper end to the lower end of the heater 11.

Next, fluorine is added to the porous glass base material G. Fluorine is added by heating the porous glass base material G while supplying the fluorine-compound-containing gas in a state in which the inside of the furnace core tube 12 is evacuated. As an example of this process, the porous glass base material G is first heated to a predetermined temperature by the heater 11. Next, the vacuum pump 20 is operated, the flow control valve 23 and the gate valve 26 are opened, the inside of the heating furnace 10 and the furnace core tube 12 is caused to be in a vacuum state, and the fluorine compound gas is supplied from the gas supply device 30 to the furnace core tube 12 via the gas supply port 31. Accordingly, in a state in which the fluorine-compound-containing gas is supplied, the porous glass base material G is heated by the heater 11. The fluorine-compound-containing gas may include, for example, CF₄ (carbon tetrafluoride) as a fluorine compound. The fluorine-compound-containing gas may also include nitrogen, argon, helium, or the like in addition to the fluorine compound. The heating temperature when fluorine is added to the porous glass base material G is, for example, 1,000° C to and 1,400° C.

The pressure inside the furnace core tube 12 when fluorine is added to the porous glass base material G may be 10 Pa to 50,000 Pa or may be 100 Pa to 30,000 Pa. The pressure inside the furnace core tube 12 is measured by the first pressure gauge 41. The pressure inside the heating furnace 10 when fluorine is added to the porous glass base material G may be 5 Pa to 40,000 Pa and may be 10 Pa to 20,000 Pa. The pressure inside the heating furnace 10 is measured by the second pressure gauge 42. In this embodiment, the porous glass base material G accommodated in the furnace core tube 12 is heated by the heater 11 to 1,000° C to 1,400° C, and fluorine-compound-containing gas is supplied into the furnace core tube 12 in a state in which the pressure measured by the first pressure gauge 41 is greater than the pressure measured by the second pressure gauge 42, and the pressure difference is maintained at 5 Pa to 10,000 Pa. The furnace core tube 12 and the top lid 13 are in close contact with each other, the inside of the furnace core tube 12 is sealed from the inside of the heating furnace 10, thereby creating a pressure difference between the inside and outside of the furnace core tube 12.

Next, the porous glass base material G to which fluorine is added is further heated by the heater 11 to dehydrate and consolidate the porous glass base material. The heating temperature during dehydration and consolidation is, for example, 1,100° C to 1,500° C. By dehydrating and consolidating the porous glass base material G, a clarified glass base material is obtained.

In the related art, when fluorine is tried to be added to a porous glass base material during vacuum consolidation, the pressure inside the furnace core tube is low, and thus fluorine cannot be sufficiently added in some cases. In order to sufficiently add fluorine, it is necessary to increase the pressure inside the furnace core tube, for example, by increasing the supply amount of fluorine-compound-containing gas. However, if the furnace core tube is not sufficiently airtight, the gas supplied into the furnace core tube leaks from the furnace core tube into the heating furnace. Therefore, in order to increase the pressure inside the furnace core tube, the entire pressure inside the heating furnace must be increased, and it is necessary to supply an excessive amount of gas.

The glass base material manufacturing device 1 according to this embodiment is equipped with the first pressure gauge 41 that measures the pressure inside the furnace core tube 12 and the second pressure gauge 42 that measures the pressure inside the heating furnace 10. According to this configuration, by causing the pressure inside the furnace core tube 12 to be higher than the pressure inside the heating furnace 10, it is possible to confirm whether the fluorine-compound-containing gas is sufficiently supplied to the inside of the furnace core tube 12, so that a high concentration of fluorine can be added to the glass base material. By adding fluorine in a state in which the pressure inside the furnace core tube 12 is higher than the pressure inside the heating furnace 10, it is not necessary to excessively supply the fluorine-compound-containing gas, and thus it is possible to reduce the usage amount of gas.

As illustrated in FIG. 1, the manufacturing device 1 of the present embodiment may also include a differential pressure gauge 43. The differential pressure gauge 43 displays a difference between the measurement value of the first pressure gauge 41 and the measurement value of the second pressure gauge 42, that is, the differential pressure between the pressure inside the furnace core tube 12 and the pressure inside the heating furnace 10. By providing the differential pressure gauge 43, it is possible to easily know the airtight state of the furnace core tube 12, and thus a high concentration of fluorine can be more reliably added to the porous glass base material G.

In the manufacturing device 1, by controlling the flow control valve 33 provided in the gas supply pipe 32, the flow rate of the fluorine-compound-containing gas supplied into the furnace core tube 12 can be controlled, for example, so that the measurement value of the first pressure gauge 41 becomes a predetermined set pressure. By adjusting the pressure inside the furnace core tube 12 to the predetermined set pressure, it is possible to more reliably add fluorine to the porous glass base material G at a high concentration. Furthermore, by controlling the flow control valve 23 provided in the gas exhaust pipe 22, the flow rate of the fluorine-compound-containing gas supplied into the furnace core tube 12 can be controlled, for example, so that the measurement value of the first pressure gauge 41 becomes a predetermined set pressure. By adjusting the pressure inside the furnace core tube 12 to the predetermined set pressure, it is possible to more reliably add fluorine to the porous glass base material G at a high concentration. The flow control valves 33 and 23 are examples of control devices in the present disclosure.

The top lid 13 of the manufacturing device 1 may have a flat lid structure in which the top lid fits tightly only to the upper end of the furnace core tube 12 or may have a cap lid structure in which the top lid also covers the upper side surface of the furnace core tube 12 as illustrated in FIG. 1. When the top lid 13 has a cap lid structure, the top lid fits tighter to the furnace core tube 12, and thus airtightness is improved. Therefore, it is easier to increase the pressure inside the furnace core tube 12.

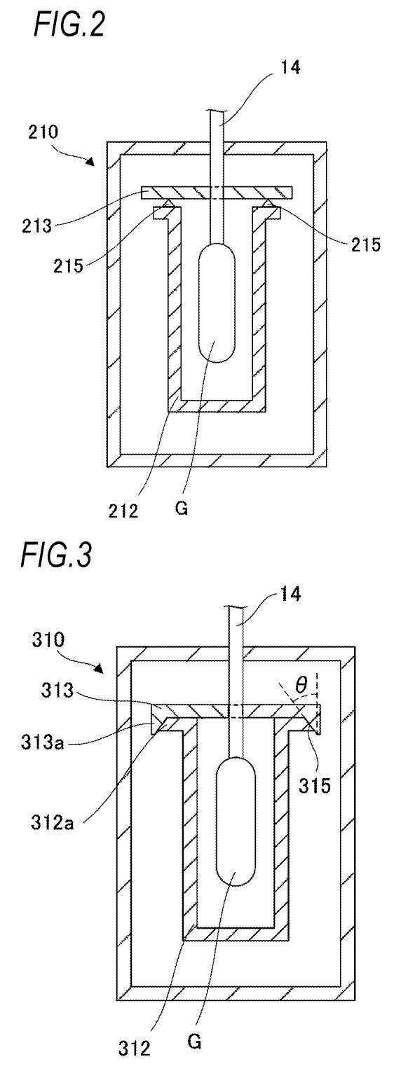

Another example of the configurations of the furnace core tube or the top lid is described with reference to the drawings. FIG. 2 is a cross-sectional view of a heating furnace 210 including a furnace core tube 212 and a top lid 213. Note that some of the components illustrated in FIG. 1 are omitted in FIG. 2 as appropriate, and this also applies to subsequent figures. As illustrated in FIG. 2, the upper end of the furnace core tube 212 is provided with protrusions 215 protruding toward the top lid 213. Although not illustrated in the figure, the protrusions 215 are provided, without a gap, along the upper end of the furnace core tube 212 so as to surround the upper opening of the furnace core tube 212. The protrusions 215 come into contact with the top lid 213 to seal the upper opening of the furnace core tube 212. By providing the protrusions 215, the surface pressure at the contact points between the furnace core tube 212 and the protrusions 215 increases, so that the protrusions 215 are bitten into the top lid 213, and the furnace core tube 212 is sealed. Therefore, the airtightness of the furnace core tube 212 is improved. The shape of the protrusion 215 is not particularly limited; for example, the portion that comes into contact with the top lid 213 may be flat.

FIG. 3 is a cross-sectional view of a heating furnace 310 including a furnace core tube 312 and a top lid 313. As illustrated in FIG. 3, a tapered portion 312a is provided at the horizontal end of the upper end of the furnace core tube 312, and a tapered portion 313a is provided at the horizontal end of the top lid 313. The tapered portion 312a of the furnace core tube 312 and the tapered portion 313a of the top lid 313 can fit together, and the fitting of the tapered portions 312a and 313a seals the upper opening of the furnace core tube 312. With this configuration, the fitting of the tapered portions 312a and 313a can improve the airtightness of the furnace core tube 312. The angle formed by the tapered portion 312a of the furnace core tube 312 and the angle formed by the tapered portion 313a of the top lid 313 are preferably equal, because the airtightness of the furnace core tube 312 is improved when the tapered portions are fitted together.

In FIG. 3, an angle θ formed by a fitting portion 315 of the tapered portions 312a and 313a and the vertical direction may be 5 degrees to 45 degrees. The fitting portion 315 is the contact surface when the tapered portion 312a and the tapered portion 313a are fitted. By setting the angle θ between the fitting portion 315 and the vertical direction to be from 5 degrees to 45 degrees, it is easy to precisely align the top lid 313 when the tapered portions 312a and 313a are fitted. That is, it becomes easy to align the top lid 313 so that the center of the top lid 313 is positioned in the central axis of the furnace core tube 312.

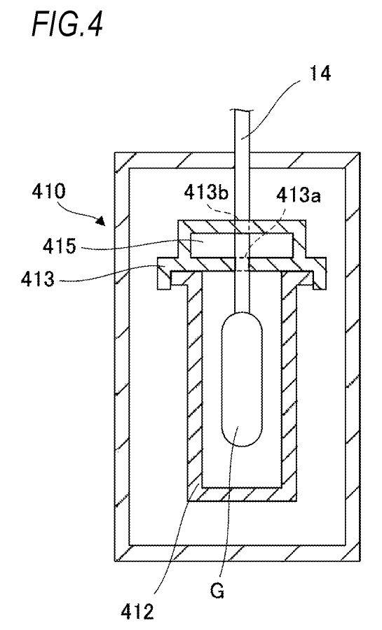

FIG. 4 is a cross-sectional view of a heating furnace 410 including a top lid 413. As illustrated in FIG. 4, the top lid 413 includes a sealing chamber 415, and the rod 14 supporting the porous glass base material G is configured to pass through the sealing chamber 415. The sealing chamber 415 is spatially separated from the inside of a furnace core tube 412 and the inside of the heating furnace 410. The configuration of the heating furnace 410 is described below in comparison with the heating furnace 10 illustrated in FIG. 1.

In the heating furnace 10 illustrated in FIG. 1, the top lid 13 is provided with the hole 13a through which the rod 14 passes. To improve the airtightness of the furnace core tube 12, the size of the hole 13a is designed to match the outer diameter of the rod 14. However, in order to cause the rod 14 passing through the top lid 13 to move up and down, a small gap is created between the top lid 13 and the rod 14. There is a risk of gas leaking from the furnace core tube 12 into the heating furnace 10 through the gap created in the hole 13a.

Meanwhile, in the heating furnace 410 illustrated in FIG. 4, the sealing chamber 415 is provided in the top lid 413. The rod 14 passes through holes 413a and 413b provided in the top lid 413. In the present embodiment, by providing the sealing chamber 415, gas is prevented from leaking directly from the furnace core tube 412 into the heating furnace 410. Since gas has to move through the two holes 413a and 413b to leak from the furnace core tube 412 into the heating furnace 410, leakage of the gas is suppressed, compared to a case where gas leaks directly from the furnace core tube 12 through the single hole 13a, as in the heating furnace 10. Accordingly, the airtightness of the furnace core tube 412 can be increased, and a pressure difference between the inside of the furnace core tube 412 and the inside of the heating furnace 410 is easily created. As is clear from the above description, the above-described expression "the sealing chamber 415 is spatially separated from the inside of a furnace core tube 412 and the inside of the heating furnace 410" does not exclude a configuration in which these spaces communicate through a gap between the rod 14 and the top lid 413. This expression means that the gap between the sealing chamber 415 and the inside of the furnace core tube 412 and the inside of the heating furnace 410, which is generated when the rod 14 is inserted, is sufficiently small, and the sealing chamber 415 reduces gas leakage from the furnace core tube 412 to the heating furnace 410.

The present embodiment may be configured so that sealing gas is supplied to the sealing chamber 415. By supplying sealing gas to the sealing chamber 415, the sealing effect can be further improved. Examples of sealing gas include nitrogen, argon, and helium.

If the top lid includes a sealing chamber, the number of sealing chambers may be one or may be two or more. As the number of sealing chambers becomes greater, the airtightness inside the furnace core tube can be improved.

### Method of Manufacturing Glass Base Material

The present disclosure relates to a method of manufacturing a glass base material using the glass base material manufacturing device. That is, the method of manufacturing a glass base material according to an embodiment of the present disclosure is a method of manufacturing a glass base material using the glass base material manufacturing device 1, and the method includes a step of heating the porous glass base material G accommodated in the furnace core tube 12 to 1,000° C to 1,400° C by the heater 11 and supplying fluorine-compound-containing gas to the furnace core tube 12 in a state in which the pressure measured by the first pressure gauge 41 is greater than the pressure measured by the second pressure gauge 42, and a pressure difference between the first pressure gauge and the second pressure gauge is maintained at 5 Pa to 10,000 Pa. According to this configuration, while fluorine is added to the glass base material at a high concentration, the usage amount of the fluorine-compound-containing gas can be reduced. Specific conditions such as pressure and temperature of the inside of the furnace core tube 12 or the heating furnace 10 that may be exemplified in the method of manufacturing a glass base material according to the present embodiment are the same as those described above for the manufacturing process using the glass base material manufacturing device 1.

The fluorine-compound-containing gas may contain CF₄ as the fluorine compound. By using gas including CF₄, it is possible to appropriately add fluorine to the glass base material.

The present disclosure is not limited to the embodiment specifically described above. In the manufacturing device 1 according to the embodiment illustrated in FIG. 1, a configuration in which the gas supply port 31 is provided in the upper portion of the furnace core tube 12, and the gas exhaust port 21 is provided in the lower portion of the furnace core tube 12 is described, but the positions of the gas supply port and the gas exhaust port are not particularly limited. For example, the gas supply port may be provided in the lower portion of the furnace core tube, and the gas exhaust port may be provided in the lower portion of the furnace core tube. The position of the gas exhaust port provided in the heating furnace is not particularly limited.

The flow control valve and the gate valve included in the manufacturing device may be collectively controlled by one control unit or may be controlled by control units different from each other. The pressure value measured by the pressure gauge may be sent to the control unit, and the control unit may control the opening and closing of the flow control valve or the gate valve based on the pressure value received. In addition to the flow control valve and the gate valve, an auxiliary valve or a bypass pipe for adjusting the gas flow rate may be further provided. Instead of the flow control valve or the gate valve, another flow regulator such as a mass flow controller may be used.

A case where fluorine is added to a porous glass base material, and then the porous glass base material is dehydrated and consolidated to obtain a clarified glass base material is described. However, the dehydration process may also be performed before adding fluorine to the porous glass base material.

What is claimed is:

1. A glass base material manufacturing device comprising:
a heating furnace;
a heater disposed inside the heating furnace;
a furnace core tube disposed inside the heater and configured to accommodate a porous glass base material inside thereof;
a top lid configured to close an upper opening of the furnace core tube;
a vacuum pump configured to evacuate the inside of the furnace core tube and the heating furnace;
a first pressure gauge configured to measure pressure inside the furnace core tube;
a second pressure gauge configured to measure pressure inside the heating furnace but outside the furnace core tube; and
a gas supply device configured to supply fluorine-compound-containing gas to the inside of the furnace core tube.

2. The glass base material manufacturing device according to claim 1, further comprising: a differential pressure gauge configured to display a differential pressure between the pressure inside the furnace core tube and the pressure inside the heating furnace but outside the furnace core tube.

3. The glass base material manufacturing device according to claim 1, further comprising: a control device configured to control a flow rate of gas supplied to the inside of the furnace core tube so that a measurement value of the first pressure gauge is predetermined set pressure.

4. The glass base material manufacturing device according to claim 1, further comprising: a control device configured to control a flow rate of gas exhausted from the inside of the furnace core tube so that a measurement value of the first pressure gauge is predetermined set pressure.

5. The glass base material manufacturing device according to claim 1, wherein the top lid includes a cap lid structure that covers an upper side surface of the furnace core tube.

6. The glass base material manufacturing device according to claim 1, wherein a protrusion that protrudes toward the top lid is provided at an upper end of the furnace core tube, and the protrusion comes into contact with the top lid, thereby sealing the upper opening of the furnace core tube.

7. The glass base material manufacturing device according to claim 1, wherein a tapered portion of an upper end of the furnace core tube and a tapered portion of the top lid are fitted to seal the upper opening of the furnace core tube.

8. The glass base material manufacturing device according to claim 7, wherein an angle formed by a fitting portion between the tapered portion of the upper end of the furnace core tube and the tapered portion of the top lid and a vertical direction is 5 degrees to 45 degrees.

9. The glass base material manufacturing device according to claim 1,
wherein the top lid includes a sealing chamber, and
a rod configured to support the porous glass base material is configured to pass through the sealing chamber.

10. A method of manufacturing a glass base material using the glass base material manufacturing device according to claim 1, comprising:
heating a porous glass base material accommodated in the furnace core tube to 1,000°C to 1,400°C by the heater and supplying fluorine-compound-containing gas to the furnace core tube in a state in which pressure measured by the first pressure gauge is greater than pressure measured by the second pressure gauge, and a pressure difference between the first pressure gauge and the second pressure gauge is maintained at 5 Pa to 10,000 Pa.

11. The method of manufacturing a glass base material according to claim 10, wherein the fluorine-compound-containing gas is CF₄.
